(19) United States
(12) Patent Application Publication
(10) Pub. No.: US 2025/0118757 A1
(43) Pub. Date: Apr. 10, 2025

(54) DRY ELECTRODES FOR LITHIUM-ION BATTERIES

(71) Applicant: FORD GLOBAL TECHNOLOGIES, LLC, Dearborn, MI (US)

(72) Inventors: Insik Jeon, Novi, MI (US); Jonghwan Park, Ann Arbor, MI (US)

(21) Appl. No.: 18/481,514

(22) Filed: Oct. 5, 2023

(51) Int. Cl. H01M 4/62; H01M 4/04; H01M 10/0525

(52) U.S. Cl. CPC H01M 4/623; H01M 4/0404; H01M 4/043; H01M 4/625; H01M 10/0525

(57) ABSTRACT

An electrode assembly for a lithium-ion battery is provided. The electrode assembly may comprise a metal foil having thereon a conductive coating including a polymeric binder and a self-supporting electrode film of active material and fibrillated composite binder laminated with the metal foil such that the conductive coating is between the metal foil and self-supporting electrode film. The fibrillated composite binder may include carbon particles and a same polymeric binder.

### TECHNICAL FIELD

The present disclosure relates to dry electrodes for lithium-ion batteries and methods of making the same.

### BACKGROUND

A lithium-ion battery is a rechargeable battery wherein lithium ions move from a negative electrode to a positive electrode during discharge and in the opposite direction while charging. Batteries generally include a separator between the electrodes to physically separate the electrodes.

Electrodes are typically constructed by applying an active material onto a current collector in the presence of a binder that promotes cohesion between the active materials and adhesion to the current collector. The typical fabrication process includes a wet coating or slurry casting method wherein a solvent or aqueous solution is used to dissolve binders and mixed with the active materials to form a slurry. The slurry is then coated onto a current collector. The current collector along with the coating layer is then dried to remove the solvent from the electrode. An electrode formed without the use of solvents may allow for easier volume production but may affect dispersion of conducting agents.

### SUMMARY

According to one embodiment, an electrode assembly is provided comprising a metal foil having a conductive coating including a polymeric binder, and a self-supporting electrode film of active material and fibrillated composite binder laminated with the metal foil such that the conductive coating is between the metal foil and self-supporting electrode film. The fibrillated composite binder includes carbon particles and a same polymeric binder.

In an alternative embodiment, a battery is provided comprising a separator and a pair of electrodes sandwiching the separator therebetween. At least one of the electrodes includes laminated layers of metal foil having thereon a conductive coating including a polymeric binder and self-supporting electrode film of active material and fibrillated composite binder that includes carbon particles and a same polymeric binder.

In yet another embodiment, a method of dry fabricating a battery electrode is provided, comprising hot pressing a dry electrode mixture of active material and fibrillated composite binder, which has carbon particles and polymeric binder, to form a self-supporting electrode film and coating a current collector with a conductive coating, which includes carbon particles and a same polymeric binder, to form a coated current collector. The self-supporting electrode film is then laminated onto the coated current collector to form the battery electrode.

### BRIEF DESCRIPTION OF THE DRAWINGS

FIG. 1 is a cross-sectional view of a dry electrode according to an embodiment.

FIG. 2 is a cross-sectional view of a battery device including an exemplary dry electrode.

FIG. 3 is a diagram of a method of dry fabricating an electrode according to an embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

One of the steps in battery manufacturing generally includes the coating of active material on a metal foil to create an electrode. Electrode active materials facilitate the movement of ions during charging and discharging of a battery. Positive electrode, or cathode, active materials are typically metal oxides, including lithium cobalt oxide (LiCoO₂), lithium manganese oxide (LiMn₂O₄), lithium iron phosphate (LiFePO₄), and lithium nickel manganese cobalt oxide (LiNiMnCoO₂). Negative electrode, or anode, active materials are commonly graphite, but also include materials such as silicon and lithium titanate (Li₄Ti₅O₁₂). The metal foil is typically referred to as the current collector and is commonly aluminum foil in a positive electrode or copper foil in a negative electrode.

Fabricating electrodes generally involves combining binder materials with electrode active materials and other additives, and processed in a way that forms an electrode film before coating the electrode film on metal foil. Electrodes may be fabricated using wet or dry processes. Wet processes include the use of solvents to form a slurry comprising binder, electrode active material, and other additives. The slurry may then be applied to a current collector and calendered to form an electrode, after which the electrode must dry. Dry electrode processes reduce the time and energy necessary for fabrication because they do not require a drying step.

However, dry, solvent-free electrode fabrication processes may affect the dispersion of conducting agents over electrode active material in the electrode film. Fine conducting particles may agglomerate without a solvent or other dispersant. Thus, the electrochemical performance of a battery cell including the electrode may be affected.

According to an embodiment, an effect on dispersion of conducting agents over electrode active material in a dry fabrication process may be mitigated by using a composite binder filled with conducting agents. The composite binder may include a polymeric binder and one or more conducting agents. The polymeric binder may include polytetrafluoroethylene (PTFE), polyvinylidene fluoride (PVDF), polyethylene (PE), polyethylene oxide (PEO), elastomer, or a combination thereof. The conducting agent may include carbon black, multi-walled carbon nanotube, single-walled carbon nanotube, carbon nanostructures, graphene, or a combination thereof. The composite binder may be dry mixed with electrode active material and then dry fibrillated. Dry fibrillation may provide well-dispersed, less agglomerated conducting agents relative to electrode active materials as a result of the physical orientation of the fibrillated composite binder.

A self-supporting electrode film may then be formed by hot pressing the dry electrode mixture of electrode active material and fibrillated composite binder. In one embodiment, the self-supporting electrode film may comprise about 1 to 30 percent by weight fibrillated composite binder and about 70 to 99 weight percent of electrode active material. The self-supporting electrode film may then be laminated on a current collector to form an electrode.

According to another embodiment, lamination and adhesion strength of the self-supporting electrode film on the current collector may be improved through the use of a thin conductive coating applied to the current collector preceding lamination. The conductive coating may provide a greater surface area and increased compatibility with the fibrillated composite binder. The conductive coating may include binder and conductive particles. The binder may have a similar surface energy as the fibrillated composite binder of the electrode film and may include PTFE, PVDF, PE, PEO, elastomer, or a combination thereof. The similar surface energy may enhance lamination and adhesion strength of the electrode film on the current collector. The conductive particles may be carbon particles including carbon black, carbon nanostructures, or combinations thereof, having an average particle size of less than 2 μm. In one embodiment the conductive coating may comprise about 50 to 99 percent by weight of conductive particles and about 1 to 50 percent by weight of binder. The conductive coating may have a thickness of less than 10 μm.

After the conductive coating is applied to the current collector, the self-supporting electrode film and coated current collector may be laminated to form a dry electrode with improved adhesion.

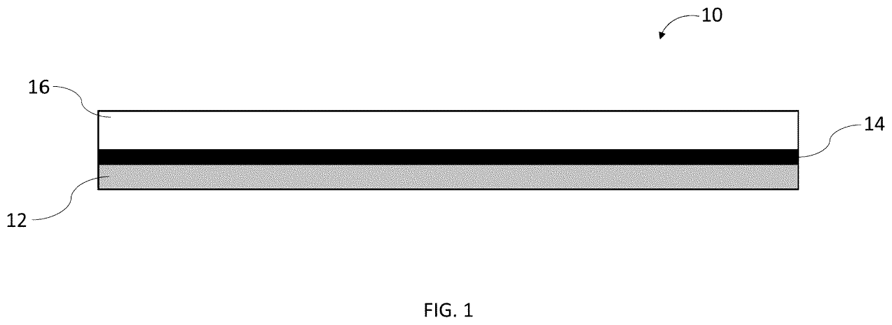

FIG. 1 is a cross-sectional view of dry electrode 10 according to an embodiment. Dry electrode 10 comprises metal foil 12 having thereon conductive coating 14 and self-supporting electrode film 16 laminated onto metal foil 12 wherein conductive coating 14 is between metal foil 12 and self-supporting electrode film 16. Metal foil 12 may be aluminum or copper foil and may be referred to as the current collector.

Self-supporting electrode film 16 includes electrode active material and fibrillated composite binder. Self-supporting electrode film 16 may be about 1 to 30 percent by weight of fibrillated composite binder and about 70 to 99 percent by weight of active material. The fibrillated composite binder includes carbon particles and polymeric binder. The polymeric binder may include PTFE, PVDF, PE, PEO, elastomer, or a combination thereof, and the carbon particles may include carbon black, multi-walled carbon nanotube, single-walled carbon nanotube, carbon nanostructures, graphene, or a combination thereof.

Conductive coating 14 includes a polymeric binder that may include PTFE, PVDF, PE, PEO, elastomer, or a combination thereof. The polymeric binder may be the same polymeric binder of the fibrillated composite binder of self-supporting electrode film 16. Conductive coating 14 may further include carbon particles including carbon black, carbon nanostructures, or combinations thereof. Conductive coating 14 may be about 50 to 99 percent by weight of carbon particles and about 1 to 50 percent by weight of polymeric binder. Conductive coating 14 may have a thickness of 10 μm or less.

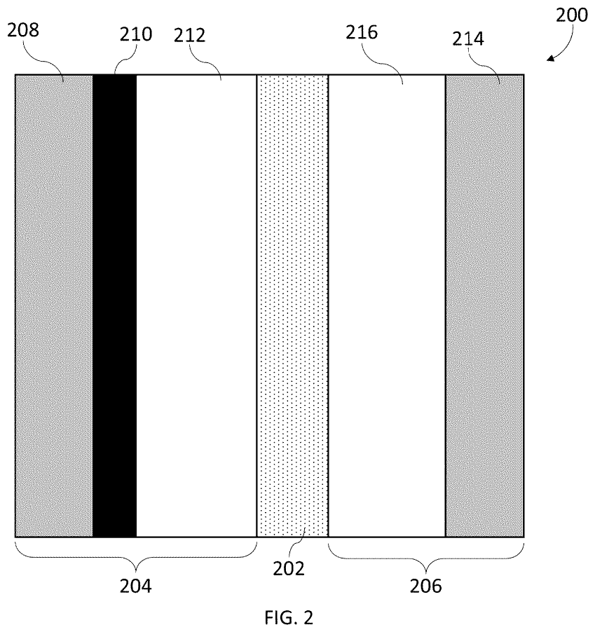

FIG. 2 is a cross-sectional view of battery device 200 including an exemplary dry electrode according to an embodiment. Battery device 200 includes separator 202 in between electrode 204 and electrode 206. In a variation, electrode 204 may be a positive electrode, and electrode 206 may be a negative electrode. In another variation, electrode 204 may be a negative electrode, and electrode 206 may be a positive electrode. As shown, electrode 204 includes metal foil 208 having thereon conductive coating 210 and self-supporting electrode film 212 laminated onto metal foil 208 wherein conductive coating 210 is between metal foil 208 and self-supporting electrode film 212. Metal foil 208 may be aluminum or copper foil.

Self-supporting electrode film 212 includes electrode active material and fibrillated composite binder. Self-supporting electrode film 212 may be about 1 to 30 percent by weight of fibrillated composite binder and about 70 to 99 percent by weight of active material. The fibrillated composite binder includes carbon particles and polymeric binder. The polymeric binder may include PTFE, PVDF, PE, PEO, elastomer, or a combination thereof, and the carbon particles may include carbon black, multi-walled carbon nanotube, single-walled carbon nanotube, carbon nanostructures, graphene, or a combination thereof.

Conductive coating 210 includes a polymeric binder that may include PTFE, PVDF, PE, PEO, elastomer, or a combination thereof. The polymeric binder may be the same polymeric binder of the fibrillated composite binder of self-supporting electrode film 212. Conductive coating 210 may further include carbon particles including carbon black, carbon nanostructures, or combinations thereof. Conductive coating 210 may be about 50 to 99 percent by weight of carbon particles and about 1 to 50 percent by weight of polymeric binder. Conductive coating 210 may have a thickness of 10 μm or less.

Electrode 206 includes metal foil 214 and self-supporting electrode film 216. Self-supporting electrode film 216 may include electrode active material and fibrillated composite binder. Self-supporting electrode film 216 may be about 1 to 30 percent by weight of fibrillated composite binder and about 70 to 99 percent by weight of active material. The fibrillated composite binder includes carbon particles and polymeric binder. The polymeric binder may include PTFE, PVDF, PE, PEO, elastomer, or a combination thereof, and the carbon particles may include carbon black, multi-walled carbon nanotube, single-walled carbon nanotube, carbon nanostructures, graphene, or a combination thereof. In an embodiment, electrode 206 may further include a conductive coating between metal foil 214 and self-supporting electrode 216.

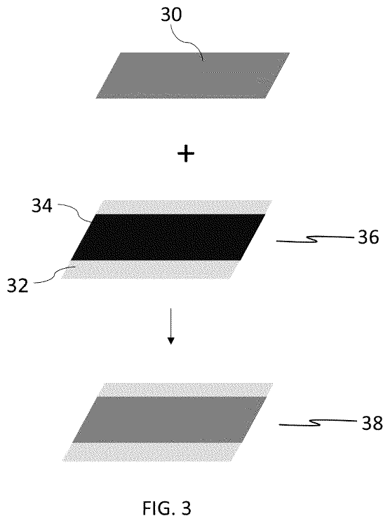

FIG. 3 is a diagram showing a method of dry fabricating electrode 38. First, a dry electrode mixture of electrode active material and fibrillated composite binder is hot pressed to form self-supporting electrode film 30. The fibrillated composite binder includes carbon particles and polymeric binder. The polymeric binder may include PTFE, PVDF, PE, PEO, elastomer, or a combination thereof, and the carbon particles may include carbon black, multi-walled carbon nanotube, single-walled carbon nanotube, carbon nanostructures, graphene, or a combination thereof. Self-supporting electrode film 30 may be about 1 to 30 percent by weight of fibrillated composite binder and about 70 to 99 percent by weight of active material.

Next, metal foil 32 is coated with conductive coating 34 to form coated current collector 36. Metal foil 32 may be aluminum or copper foil. Conductive coating 34 includes a polymeric binder that may include PTFE, PVDF, PE, PEO, elastomer, or a combination thereof. The polymeric binder may be the same polymeric binder of the fibrillated composite binder of self-supporting electrode film 30. Conductive coating 34 may further include carbon particles including carbon black, carbon nanostructures, or combinations thereof. Conductive coating 34 may be about 50 to 99 percent by weight of carbon particles and about 1 to 50 percent by weight of polymeric binder. Conductive coating 34 may have a thickness of 10 μm or less.

Lastly, self-supporting electrode film 30 is laminated onto coated current collector 36 to form electrode 38. Notably, the method of dry fabrication does not include use of solvents.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electrode assembly comprising:
a metal foil having thereon a conductive coating including a polymeric binder; and
a self-supporting electrode film of active material and fibrillated composite binder, which includes carbon particles and a same polymeric binder, laminated with the metal foil such that the conductive coating is between the metal foil and self-supporting electrode film.

2. The electrode assembly of claim 1, wherein the carbon particles include carbon black and nanostructures.

3. The electrode assembly of claim 2, wherein the nanostructures are multi-walled, single-walled, graphene, or combinations thereof.

4. The electrode assembly of claim 1, wherein the self-supporting electrode film is 1 to 30 percent by weight of the fibrillated composite binder.

5. The electrode assembly of claim 1, wherein the self-supporting electrode film is 70 to 99 percent by weight of the active material.

6. The electrode assembly of claim 1, wherein the conductive coating further includes carbon particles.

7. The electrode assembly of claim 6, wherein the carbon particles of the conductive coating include carbon black, nanostructures, or combinations thereof.

8. The electrode assembly of claim 6, wherein the conductive coating is 50 to 99 percent by weight of the carbon particles of the conductive coating.

9. The electrode assembly of claim 1, wherein the conductive coating is 1 to 50 percent by weight of the polymeric binder.

10. The electrode assembly of claim 1, wherein a thickness of the conductive coating is 10 μm or less.

11. A battery comprising:
a separator; and
a pair of electrodes sandwiching the separator therebetween, at least one of the electrodes including laminated layers of (i) metal foil having thereon a conductive coating including a polymeric binder and (ii) self-supporting electrode film of active material and fibrillated composite binder that includes carbon particles and a same polymeric binder.

12. The battery of claim 11, wherein the carbon particles include carbon black and nanostructures.

13. The battery of claim 12, wherein the nanostructures are multi-walled, single-walled, graphene, or combinations thereof.

14. The battery of claim 11, wherein the self-supporting electrode film is 1 to 30 percent by weight of the fibrillated composite binder.

15. The battery of claim 11, wherein the conductive coating is 1 to 50 percent by weight of the polymeric binder.

16. The battery of claim 11, wherein the conductive coating further includes carbon particles.

17. The battery of claim 12, wherein the carbon particles of the conductive coating include carbon black, nanostructures, or combinations thereof.

18. The battery of claim 11, wherein a thickness of the conductive coating is 10 μm or less.

19. A method of dry fabricating a battery electrode, comprising:
hot pressing a dry electrode mixture of active material and fibrillated composite binder, that has carbon particles and polymeric binder, to form a self-supporting electrode film;
coating a current collector with a conductive coating, which includes carbon particles and a same polymeric binder, to form a coated current collector; and
laminating the self-supporting electrode film onto the coated current collector to form the battery electrode.
